(19) United States
(12) Patent Application Publication
(10) Pub. No.: US 2023/0108296 A1
(43) Pub. Date: Apr. 6, 2023

(54) POINT-OF-CARE MICROFLUIDIC IN VITRO DIAGNOSTIC SYSTEM

(71) Applicant: EMERGING VIRAL DIAGNOSTICS (HK) LIMITED, HONG KONG (CN)

(72) Inventors: YUK LUN TSANG, HONG KONG (CN); LOK TING LAU, HONG KONG (CN); LUT HEY CHU, HONG KONG (CN); JOHNSON YIU--NAM LAU, HONG KONG (CN)

(73) Assignee: EMERGING VIRAL DIAGNOSTICS (HK) LIMITED, HONG KONG (CN)

(21) Appl. No.: 17/798,875

(22) PCT Filed: Feb. 10, 2021
(86) PCT No.: PCT/IB2021/051046

§ 371 Date: Aug. 10, 2022

Related U.S. Application Data
(60) Provisional application No. 62/972,119, filed on Feb. 10, 2020.

(51) Int. Cl. B01L 3/00; G01N 35/00; G01N 15/14

(52) U.S. Cl. CPC B01L 3/502753; G01N 35/00029; G01N 15/1484; B01L 2200/027; B01L 2200/16; B01L 2300/0864

(57) ABSTRACT

A fully automated microfluidic system (100) for detecting multiple different analytes in a single run comprises: a remote computer system (102), a microfluidic analyzer (300) having an illumination source and a detection module; and a cartridge (200) having a plurality of lightbulbs (224), a sample tank (204) and at least one reagent tank (210), wherein each lightbulb (224) is sealable by the microfluidic analyzer (300).

### FIELD OF INVENTION

This invention generally relates to systems and methods for detecting analyte. In particularly, aspects of the invention relate to a microfluidic system for use in various biological, chemical, or diagnostic assays and method thereof.

### BACKGROUND

The world is frequently posed with pandemic threats from a wide variety of severe respiratory syndromes throughout history, like, Hong Kong as an example, the notorious H2N2 Asian Flu in 1957 and H3N2 Hong Kong Flu in 1968, with the both caused millions of deaths. According to World Health Organization (“WHO”), seasonal influenza/epidemics are estimated to result in about 3 to 5 million cases of severe illness, and about 290,000 to 650,000 respiratory deaths worldwide. If a 1918-type influenza pandemic (like the Spanish flu) is to be happening today, it is projected to cause 180-360 million deaths globally. Taking the recent 2018/2019 winter influenza season in Hong Kong as another example, it has lasted for 14 weeks with Influenza A (H1) as the predominating virus. 625 severe influenza cases were recorded, with 357 deaths and at the peak time 7 deaths were recorded on one single day. The overall mortality rate was 57%, and at the age group of 65 or above in particular, the mortality rate was as high as 80%.

New and contagious viral pathogens, including but not limited to Avian Influenza subtype H5N1 in 1997, SARS in 2003, pandemic H1N1 (swine flu) in 2009, H7N9 in 2013 and most recently MERS-CoV have appeared in the last few decades and the mortality rate of these pathogens is extremely high, with over 15% for SARS CoV and even up to 50% for H5N1. These new and contagious pathogens have caused thousands of people being hospitalized and hundreds of deaths.

Severe and less severe respiratory infections such as the common upper and lower respiratory tract disorders all present with indiscriminative influenza-like symptoms such as fever, cough, headache, body aches and nasal congestion, making differential diagnosis of different infectious pathogens is difficult without laboratory testing. Samples from patients with suspected symptoms is needed to be delivered to laboratories with molecular testing facilities, which mostly lies in government or hospital facilities. The whole procedure may also take days to complete. The frontline medical practitioners, especially those practice in private clinics and laboratories where likely do not have the viruses testing capability, have difficulties to differentiate whether a patient requires hospitalization or even isolation. This is because the time required to make differential diagnosis is too simply too long. This poses tremendous impact and pressure on the clinical and public healthcare system and could stir unnecessary public fear in most of the less severe respiratory infection cases in pandemic.

### SUMMARY

In view of the foregoing background, time and accessibility become the critical factors of differential diagnosis.

To alleviate the issues, aspects of the invention provide a point-of-care (POC) diagnostic tool with signatures of a simplicity, ease to operate, high speed, affordable cost and yet highly sensitive and specific in vitro diagnostic (IVD) device. Such device can be placed in most of the frontline medical units including clinics, laboratories and public health facilitates to allow rapid testing for suspected patients and to determine whether they are being infected with any one of the contagious viruses. The POC diagnostic tool of the present invention further provides a system to control spreading of virus among people in their communities.

Further aspect of the present invention is to provide a rapid, accurate, multiplex, low cost, sample-to-result, high throughput fully automated system for use in various biological, chemical, or diagnostic assays.

Another aspect of the present invention is to simplify the assay work procedure into a one-stop solution using complete automation. It combines a number of complicated work procedures found in traditional assay.

Yet another aspect of the present invention is to provide a fully automated test and to detect up to 40 respiratory pathogens in a single run in about an hour.

To sum up, the present invention helps to solve the following challenges in diagnostic: (i) lack of comprehensive multiplexing ability; (ii) lack of extended strain coverage prevalent; (iii) low local or regional significance; (iv) high cost on equipment and assay; (v) complicated sample-to-result handling; (iv) inability in identifying the unit of pathogens detected (i.e. only able to show qualitative result instead of quantitative ones)

Accordingly, embodiments of the present invention, in one aspect, a fully automated microfluidic system for detecting multiple different analytes in a single run comprising a remote computer system, a microfluidic analyzer having a illumination source and a detection module; and a cartridge having a plurality of lightbulbs, a sample tank and at least one reagent tank, wherein each lightbulb is sealable by the microfluidic analyzer.

In yet another aspect, a fully automated microfluidic system for detecting 40 different analytes in a single run in about approximately an hour comprising a remote computer system, a microfluidic analyzer having a illumination source and a detection module, and a cartridge having a plurality of lightbulbs, a sample tank and at least one reagent tank.

### BRIEF DESCRIPTION OF FIGURES

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a schematic view of an example of an assay system according to one embodiment.

FIG. 2 is a schematic view of an example of a cartridge according to one embodiment.

FIG. 3 is a schematic top view of an example of a cartridge according to one embodiment.

FIG. 4 is a schematic bottom view of an example of a plurality of reagent tanks of a cartridge according to one embodiment.

FIG. 5 is a schematic view of an example of a reagent tank interface of a cartridge according to one embodiment.

FIG. 6 is a schematic view of an example of a sample port of a cartridge according to one embodiment.

FIG. 7 is a schematic view of an example of a valve of a cartridge according to one embodiment.

FIG. 8 is a schematic view of an example of an extraction module of a cartridge according to one embodiment.

FIG. 9a is a schematic view of an example of a first metering chamber of a cartridge according to one embodiment.

FIG. 9b is an schematic view of an example of a second metering chamber of a cartridge according to one embodiment.

FIG. 10 is a schematic view of an example of a reverse transcription polymerase chain reaction (RT-PCR) chamber of a cartridge according to one embodiment.

FIG. 11 is a schematic view of an example of a lightbulb quantitative polymerase chain reaction (qPCR) region of a cartridge according to one embodiment.

FIG. 12 is a schematic view of an example of a lightbulb of a cartridge according to one embodiment.

FIG. 13a is a schematic view of a row of lightbulbs in the qPCR lightbulb quantitative region of FIG. 11 prior to sealing according to one embodiment.

FIG. 13b is a schematic view of a row of lightbulbs in the qPCR lightbulb quantitative region of FIG. 11 after sealing according to one embodiment.

FIG. 14 is a schematic view of all the lightbulbs in the qPCR lightbulb quantitative region of FIG. 11 after sealing according to one embodiment.

FIG. 15a is a schematic view of an example of a sample apparatus with a cap in open position according to one embodiment.

FIG. 15b is a schematic view of the sample apparatus of FIG. 15a with the cap in close position according to one embodiment.

FIG. 15c is a schematic view of inserting the sample apparatus of FIGS. 15a and 15b into a cartridge according to one embodiment.

FIG. 16 is a schematic view of an example of a microfluidic analyzer according to one embodiment.

FIG. 17 is a diagram depicting an example of a control system of a microfluidic analyzer according to one embodiment.

FIG. 18 is a cross sectional view of an example of a sealing module in a microfluidic analyzer according to one embodiment.

FIG. 19 is an exemplary user interface of a control application at a remote computer system according to one embodiment.

FIG. 20 is flow chat depicting a workflow of an assay according to one embodiment.

FIG. 21 is flow chat depicting a workflow of an assay in a cartridge according to one embodiment.

FIG. 22a-e illustrate the sealing steps of a lightbulb according to one embodiment.

FIG. 23 illustrates the amplification curves of the 45 detectable lightbulbs of all 135 lightbulbs in a full run with control materials according to one embodiment.

FIG. 24 illustrates the amplification curved of the 45 detectable lightbulbs of all 135 lightbulbs in a full run with 20 μl clinical sample containing Influenza B virus.

FIG. 25 is a chart depicting the fields which a microfluidic system of the present invention may be applied.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

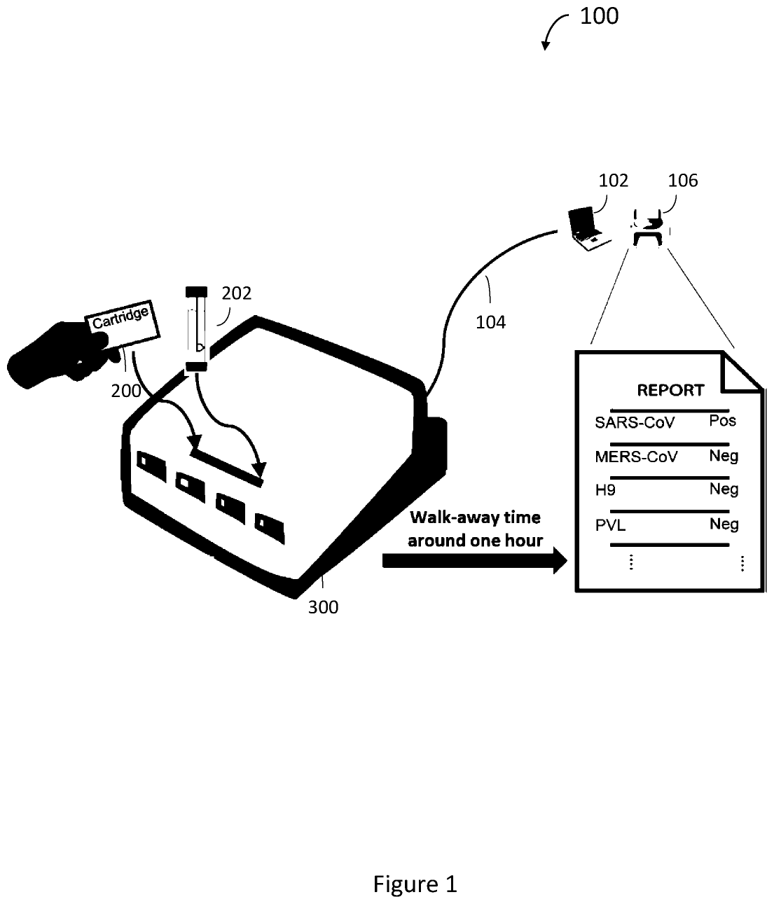

Referring to FIG. 1, an assay system 100 comprising a cartridge 200, a microfluidic analyzer 300, a sample apparatus 202, a remote computer system 102 and a communication network 104. The microfluidic analyzer 300 is configured to receive the cartridge 200 to perform assay. The microfluidic analyzer 300 may wirelessly linked to the remote computer system 102 through a WI-FI hotspot or other protocols to enable communication between the microfluidic analyzer 300 and the remote computer system 102. The remote computer system 102 may exchange data with the microfluidic analyzer 300 and control it according to parameters that a user directs toward a control application. In one example, the user may operate the control application to input operation parameters for the assay and the remote computer system 102 may generate a command signal (caused or triggered by the control application) to cause the microfluidic analyzer 300 to preform predetermined operations. The remote computer system 102 may produce and create operation reports based on data collected in the operation. The remote computer system 102 may include a microprocessor (not shown) and a computer-readable storage medium or memory (not shown) connected to the microprocessor (not shown). The remote computer system 102 may connect to a printer 106 to print out the operation reports.

In one embodiment, the operation report may contain biological or diagnostic assay information.

In one embodiment, the assay system 100 may not include the printer 106.

In one embodiment, the microfluidic analyzer 300 may comprise an interface configured to receive the collected samples.

In certain examples, the communication network 104 may not include a WI-FI hotspot network. The remote computer system 102 may communicate with the microfluidic analyzer 300 through any wireless and/or wired communication protocols.

In one embodiment, the communication network 104 is a Universal Serial Bus (USB) communications network.

In some cases, the remote computer system 102 may communicate with a cloud server platform (not shown). For example, via a communication channel, whether via WI-FI (e.g., a wireless connection) or via a wired connection, the remote computer system 102 may upload data collected during the operation to the cloud server platform. The cloud server platform may execute analysis software to enable the user to analyze the raw data collected. The cloud server platform further may produce and create operation reports based on the collected data.

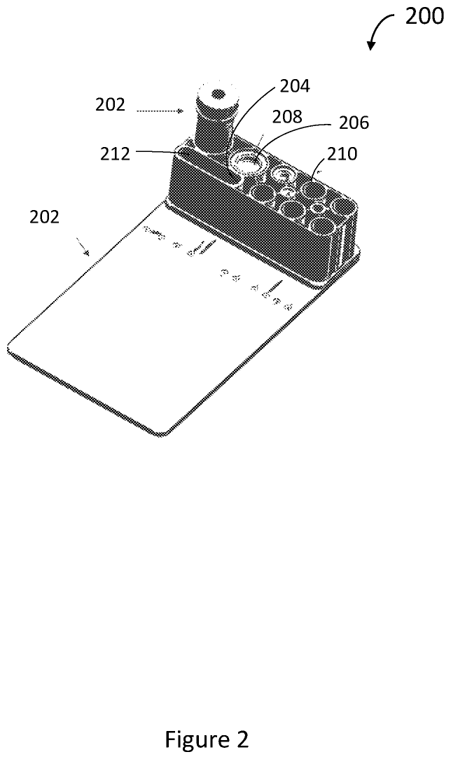

Referring to FIG. 2, the cartridge 200 comprises a cartridge base 202, wherein a sample tank 204, a lysis tank 206, a plug 208 disposed on top of the lysis tank 206, a plurality of reagent tanks 210 configured to receive or contain reagents for the assay operation, and a waste collection tank 212 are disposed therein. All the fluidic movements are realized by vertical movements of the plugs (work like syringes).

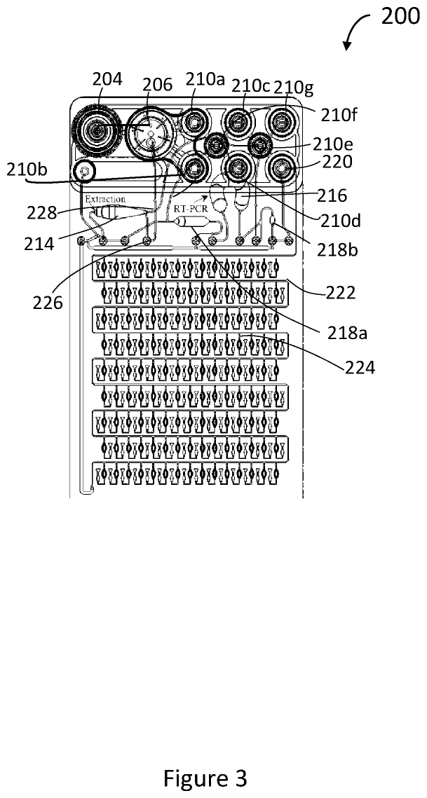

Referring to FIG. 3, the cartridge further comprises an extraction module 214, a RT-PCR chamber 216, a first metering chamber 218a, a second metering chamber 218b, a pre-qPCR tank 220, a qPCR lightbulb quantitative region 222 containing a plurality of lightbulbs 224, a plurality of microfluidic vales 226, a plurality of microfluidic channels 228 configured to direct and transfer fluids to and from at least one of the components in the cartridge 200. By controlling the plug's 208 movement and the valves' 226 on-off, well control of the fluidic movement can be realized.

In one embodiment, the cartridge 200 is made of polymer, which may include polydimethylsiloxane (PDMS), polypropylene (PP), polycarbonate (PC), polyethylene (PE), polyethylene terephthalate (PET), polymethylmethacrylate (PMMA), cyclic olefin copolymer (COC), cyclo olefin polymer (COP), silicone, urethane resin or combination thereof.

In one embodiment, the cartridge 200 is made from injection molding.

In one embodiment, silica beads or zirconium beads or both are pre-loaded/pre-coated in the lysis tank 206.

In one embodiment, the plurality of reagent tanks are configured to receive and hold at least one of the following reagents: lysis buffer, binding buffer, wash buffer, elution buffer and master-mix.

In one embodiment, the reagent tanks 210 comprises a lysis buffer reagent tank 210a containing lysis buffer, a binding buffer reagent tank 210b containing binding buffer, two washing buffer reagent tanks 210c & 210d, an elution buffer reagent tank 210e, a RT-PCR master mix tank 210f, and a real-time PCR master-mix tank 210g.

In one embodiment, the reagent tanks 210 have already been packaged with all the reagents, including but not limited to buffers and master-mix.

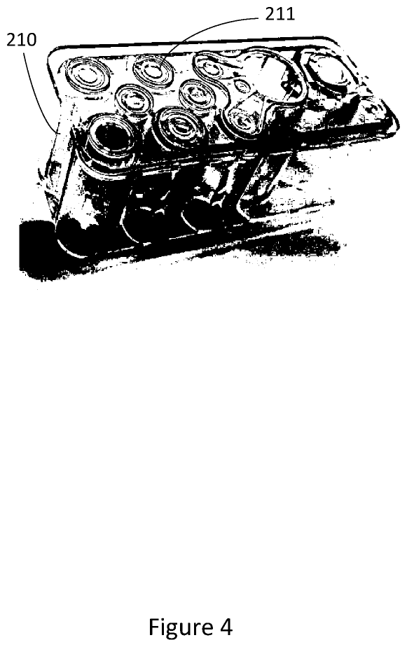

Referring FIG. 4, in one embodiment, each reagent tank 200 further comprises a cover disposed on top of the reagent tank 200 and a foil 211 disposed at the lower portion of the reagent tank 200 configured to contain the reagent in the reagent tank 200.

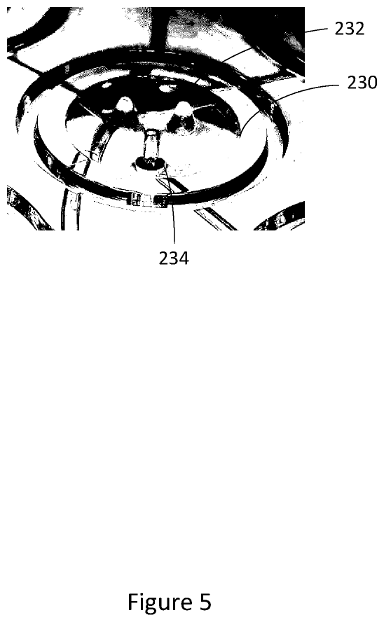

Referring FIG. 5, each reagent tank 200 further comprises a reagent tank interface 230 disposed at the bottom thereof configured to interact with the foil 211 to allow the reagent in the reagent tank 210 to flow to the microfluidic channels 228 and chambers in the cartridge 200. The reagent tank interface 230 contains at least one extrude feature 232 to pierce through the foil 211 and a protruded channel 234 configured to allow the reagent to flow from the reagent tank 210 through the pierced hole of the foil to the protruded channel 234 and to the microfluidic channels 228 and chambers in the cartridge 200. By controlling the plug's 208 movement, the foil 211 will move towards the at least one extrude feature 232 during assay operation.

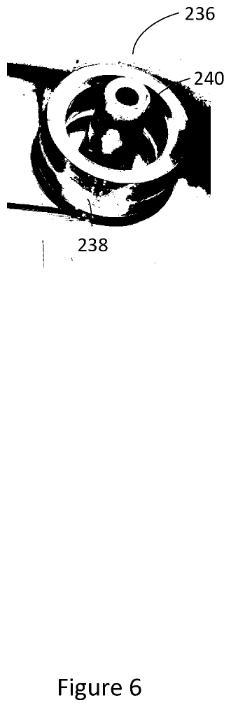

Referring to FIG. 6, the sample tank 204 further comprises a sample port 236, which comprises a ring 238 configured to receive a seal at the bottom of the sample apparatus 202 and a push up 240 configured to break the seal. The ring is configured to tight fit with the seal of the sample apparatus 202 to prevent leak of sample. The push up 240 also include a channel configured to allow the sample to flow into the other components in the cartridge 200 through microfluidic channels 228.

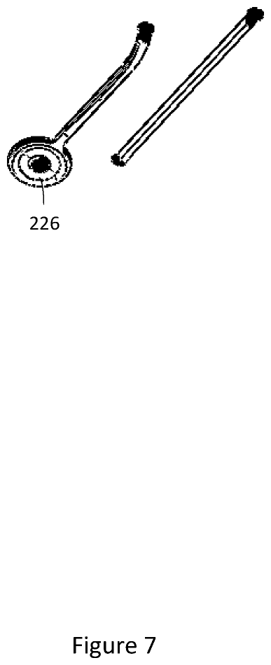

Referring to FIG. 7, the valves 226 disposed on the cartridge 200 are press to close valves 226. They are installed on the microfluidic channels 228 to control the flow of the fluid during assay operation as described in the mode of operation below.

The valves switch and select fluidic path in a control manner. They help to direct the flow of fluids in the cartridge 200 for assay operation.

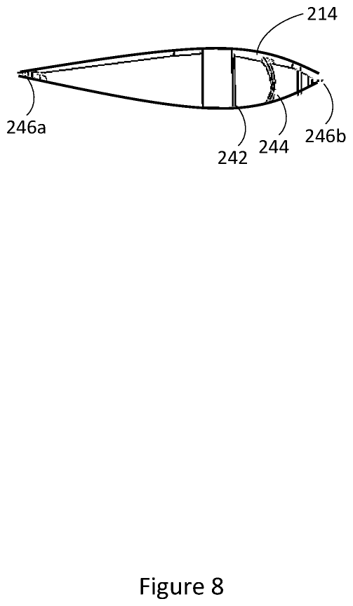

Referring to FIG. 8, the extraction module 214 comprises an elongated teardrop shaped chamber comprising a cater isolation membrane 242 configured to capture nucleic acid, a debubbler 244 and an inlet 246a and an outlet 246b disposed at each end of the elongated teardrop shaped chamber. Both the inlet 246a and outlet 246b are connected to the microfluidic channels. The longer side of the chamber could reduce bubble generation as the fluid passes through the extraction module 214. The cater isolation membrane 242 is installed at the widest part of the elongated teardrop shaped chamber. The extraction module 214 is configured to continuously receive sample for extraction and handle sample in the volume amount of milli-liter. The extraction module 214 of the present invention allows more sample/analyte to for assay, thus increase the sensitivity of the system. In some examples, the extraction module 214 could handle up to about approximately 1 ml of sample.

In one embodiment, the isolation membrane 242 is made of materials which may include crushed glass powders, glass fiber, silica membranes, silica beads, silica particles or combination thereof.

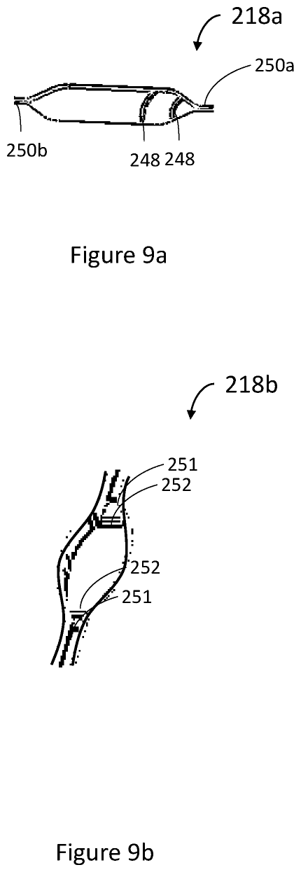

Referring FIG. 9a, the first metering chamber 218a comprises an elongated round edged octagon chamber having a defined structural volume for metering liquid volume. The oval chamber further comprises a plurality of flow restrictors 248 disposed near an inlet 250a to prevent bubble trap. An outlet 250b, which is connected to an inlet of the RT-PCR chamber 216, is disposed at the opposite end of the inlet 250a.

In other examples, the defined structural volume metering liquid volume is 10-50 ul.

Referring FIG. 9b, the second metering chamber 218b comprises an oval chamber having a defined structural volume for metering liquid volume. The oval chamber further a plurality of holes 251 disposed at each end of the oval shaped chamber. The holes 251 are connected to the microfluidic channels. A slope 252 disposed at both ends of the oval chamber and the slope gradually raised from the bottom of the oval chamber to approximately three-fifth (⅗) of the deepest depth of the oval chamber. The slopes prevent bubble trap.

In other examples, the slope gradually raised from the bottom of the oval chamber to approximately % of the deepest depth of the oval chamber.

In other examples, the defined structural volume metering liquid volume is 1-10 ul.

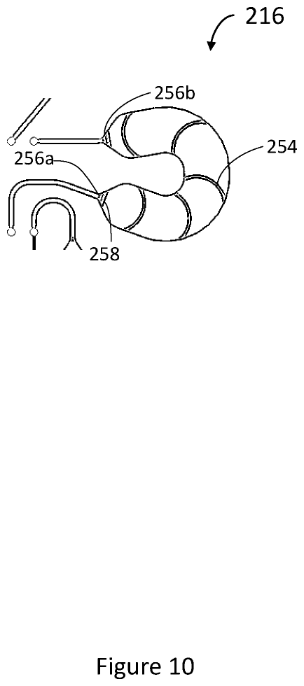

Referring to FIG. 10, the RT-PCR chamber 216 comprises a U-shaped chamber having a defined structural volume for restrict the reaction volume of PT-PCR. The chamber further comprises a plurality of flow restrictors 254 substantially equally distributed on the U-shape chamber, an inlet 256a and an outlet 256b. The inlet 256a and the outlet 256b are disposed at each end of the U-shaped chamber. The inlets 256a and outlets 256b are connected to the microfluidic channels. A slope 258 disposed at both ends of the U-shaped chamber and the slope 258 gradually raised from the bottom of the U-shaped chamber to approximately one-half (½) of the deepest depth of the U-shaped chamber.

In other examples, the defined structural volume for restrict the reaction volume is 20-100 ul.

In one embodiment, the RT-PCR chamber is made by injection mold.

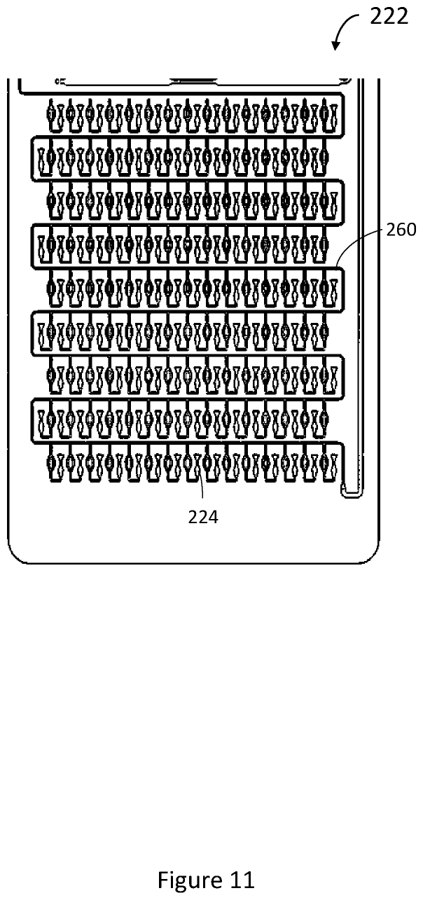

Referring FIG. 11, the qPCR lightbulb quantitative region 222 connected to the pre-qPCR tank 220 through a microfluidic channel. The qPCR lightbulb quantitative region 222 comprises a microfluidic channel 260 and a plurality of lightbulbs 224, each lightbulb 224 connects its inlet to the microfluidic channel 260.

In one embodiment, there are hundred and twenty (120) lightbulbs 224 connected to the microfluidic channel 260.

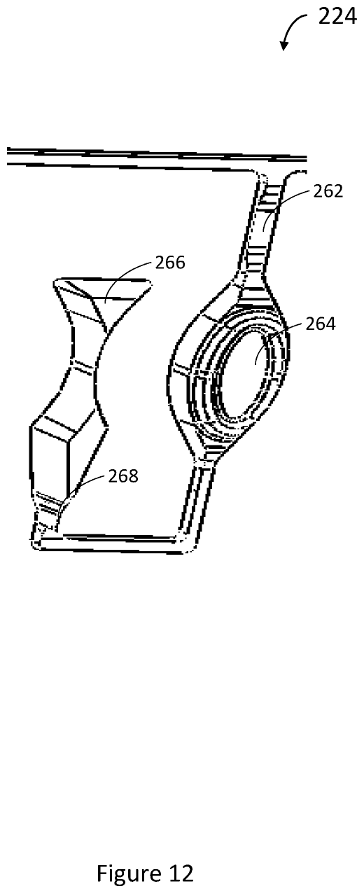

Referring FIG. 12, the lightbulb 224 comprises a sealable inlet microfluidic channel 262, a lightbulb oval chamber 264 connected to the sealable inlet microfluidic channel 262, and an upside down spade shaped chamber 266, wherein the head/tip of the upside down spade shaped chamber 266 is connected to the lightbulb oval chamber 264. The sealable inlet microfluidic channel 262 is shallower than other microfluidic channel 228 to provide sealable function. The interior surface of the lightbulb oval chamber 264 is round shaped to prevent bubble trap and the bottom surface of the lightbulb oval chamber 264 is polished to allow maximum transmission of optical signal from the interior of the lightbulb 224. The upside down spade shaped chamber 266 is configured to hold compressed air due to inflow of liquid to the oval chamber, which causes the build up of the pressure in upside down spade shaped chamber 266. The shape of the upside down spade shaped chamber 266 is designed for maximizing compartment and to prevent bubbles generation during PCR. A slope 268 disposed at the inlet of the upside down spade shaped chamber 266 and the slope 268 gradually declines from the bottom of the microfluidic channel at the inlet to the bottom of the upside down spade shaped chamber 266 to reduce bubble trap.

Each lightbulb oval chamber 264 was spotted with primers and probes followed by a drying process. When the template and master-mix was flowed into the lightbulb 224, the spotted materials were re-suspended.

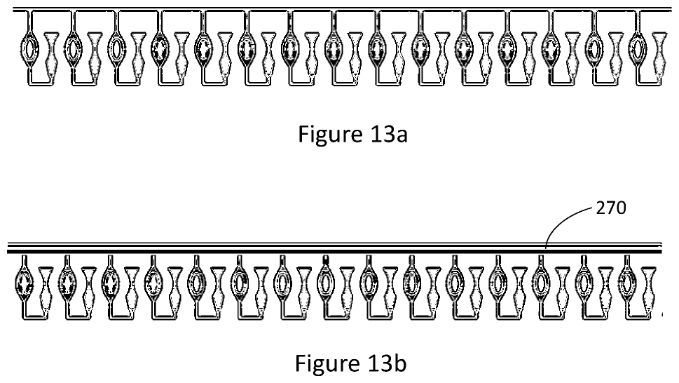

Referring FIGS. 13a and 13b, the inlet of each lightbulb 262 can be sealed and disconnected from the microfluidic channel running within the qPCR lightbulb quantitative region 222, thereby, the qPCR can be performed in an isolated lightbulbs 224. The lightbulbs 224 as shown in the FIG. 13a are in unsealed configuration and the lightbulbs 224 as shown in the FIG. 13b are in the sealed configuration. The inlet of lightbulbs 262 are sealed off by a sealing line 270. Therefore, the lightbulbs 224 can be disconnected from each other. Template in such individual lightbulb 224 can receive single PCR amplification respectively according to the primer/probe assigned.

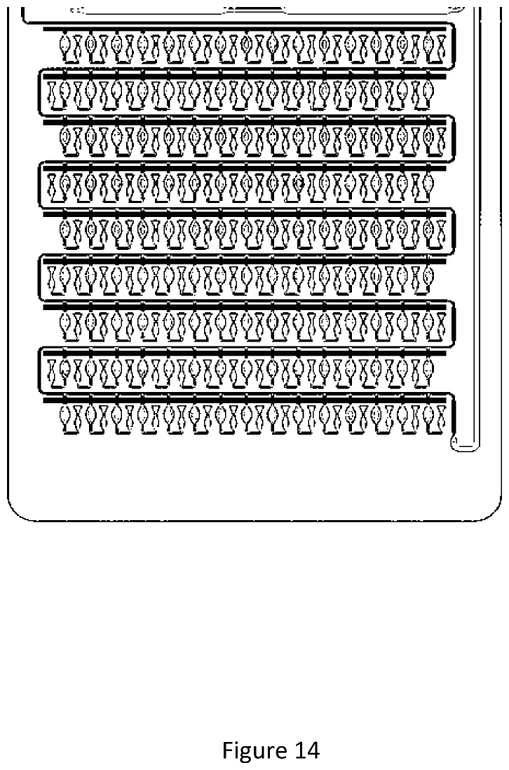

Referring FIG. 14, all the rows of lightbulbs within the qPCR lightbulb quantitative region 222 may be sealed.

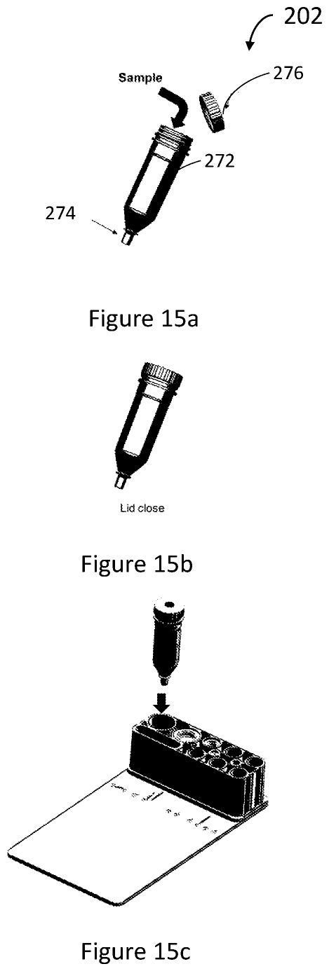

Referring FIG. 15a, the sample apparatus 202 comprising a container 272, a seal 274 and a cap 276 configured to close an opening of the container. The seal 274 prevents the sample in the container from leaking from the sample apparatus 202. The seal 274 may be opened by the sample port 236 in the manner as discussed above. The seal 274 may be made of material, which may include soft plastics, rubber, silicone, thermoplastic elastomer (TPE), thermoplastic polyurethane (TPU), thermoplastic rubber (TPR). FIG. 15b shows the sample apparatus 202 with the cap 276 is coupled with the container 272. Referring 15c, the sample apparatus 202 is detachably attached to the sample port 236. The sample apparatus 202 may be detached to collect sample and attached back to the cartridge 200 at the sample port 236 for assay. Sample in various types, such as sputum, nasopharyngeal swab and nasopharyngeal aspiration may be transferred to the sample apparatus 202.

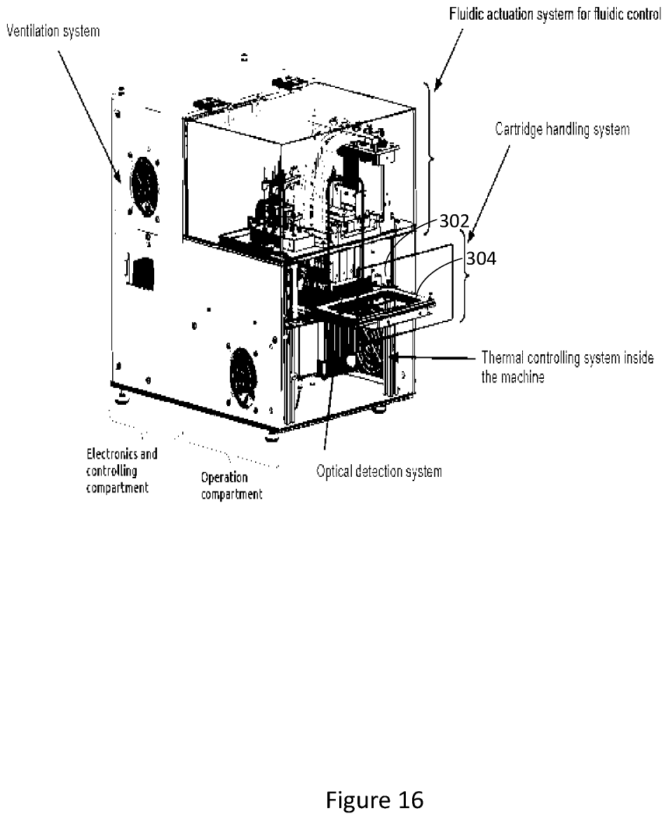

Referring FIG. 16, the microfluidic analyzer 300 comprises (i) an enclosure comprising electronic/controlling compartment and operation compartment; (ii) a fluidic actuation system disposed in the operation compartment configured to manipulate the transfer of samples and reagents within the microfluidic network on the cartridge to carry out biochemistry reactions and assay operation, (iii) a cell lysis system disposed in the operation compartment configured to break down the cell to release the DNA without damaging thereof, (iv) a thermal controlling system configured to provide designed thermal condition for carrying out biochemistry reactions; (v) optical detection system comprising a illumination source and a detection module configured to detect the fluorescent signal from the lightbulbs, for example, the signal generated by the taqMan probe in the lightbulbs; (vi) a power system configured to deliver and distribute different electrical power to different component of the microfluidic analyzer 300; (vii) a ventilation system configured to stabilized the internal temperature of the microfluidic analyzer 300; (viii) a system sensor network system configured to monitor the status of the microfluidic analyzer 300 and report faults when abnormal behavior is observed; (ix) a cartridge 200 sealing module configured to seal the cartridge 200 to form enclosed system; (x) a cartridge handling system configured to receive the cartridge 200.

The cartridge handling system further comprises a retractable tray 302, wherein the tractable tray 302 further comprises a cartridge slot 304 configured to receive the cartridge 200. In the extended position, the retractable tray 302 allows the user to load the cartridge 200 onto its cartridge slot 304. In the retracted position, the retractable tray 302 brings the cartridge 200 in the operation position where the assay can be performed. The cartridge 200 is also in the position where its qPCR lightbulb quantitative region 222 are illuminated by the illumination source and the signal emitted from the lightbulbs 224 is captured by the detection module.

In one embodiment, the illumination source emits light or electromagnetic wave at ranging from about approximately 250 nm (ultra-violet) to about approximately 880 nm (infrared). In one example, the illumination source is coped with suitable filter for different setup.

In one embodiment, the detection module is a camera.

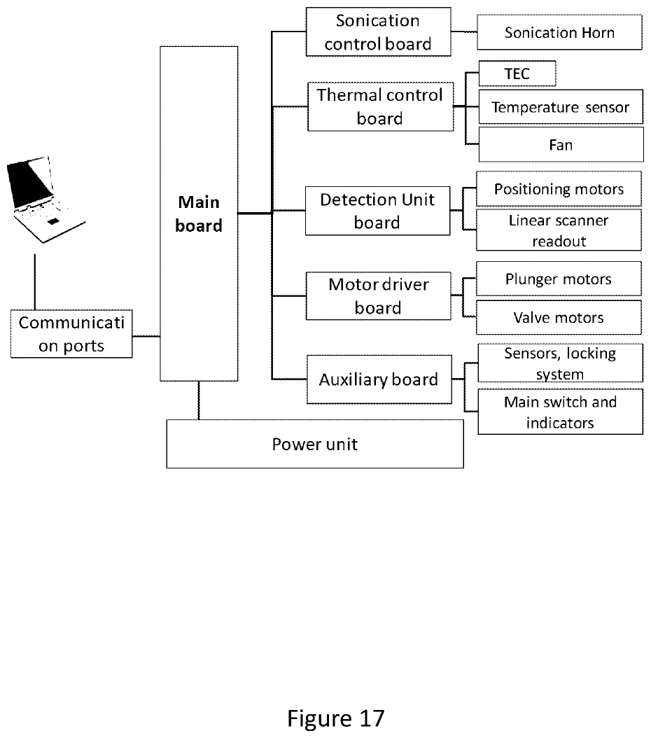

Referring FIG. 17, the microfluidic analyzer 300 further comprises a main board connected to communication port configured to connect to the remote computer system 102. The mainboard also connected to all the systems in the microfluidic analyzer 300 to perform assay. The mainboard may include a microprocessor (not shown) and a computer-readable storage medium or memory (not shown) connected to the microprocessor.

The fluidic actuation system further comprises a motor driver board, a plug motor configured to actuate the plug 208 of the cartridge, and a valve motor configured to actuate the valves 226 on the cartridge 200.

The cell lysis system further comprises a sonication control board and a sonication horn configured to interact with the lysis tank 206 of the cartridge 200.

The thermal controlling system further comprising a thermal control board, a thermoelectric heater configured to heat up the templates and reagents in the cartridge 200 during TR-PCR and qPCR, a temperature sensor and a fan. In some cases, the thermoelectric heater is a heat plate positioned below the cartridge 200 when it is at the operation position in the microfluidic analyzer 300.

The power system comprises a power unit.

The system sensor network system comprises a detection unit board, positioning motor and a linear scanner outread.

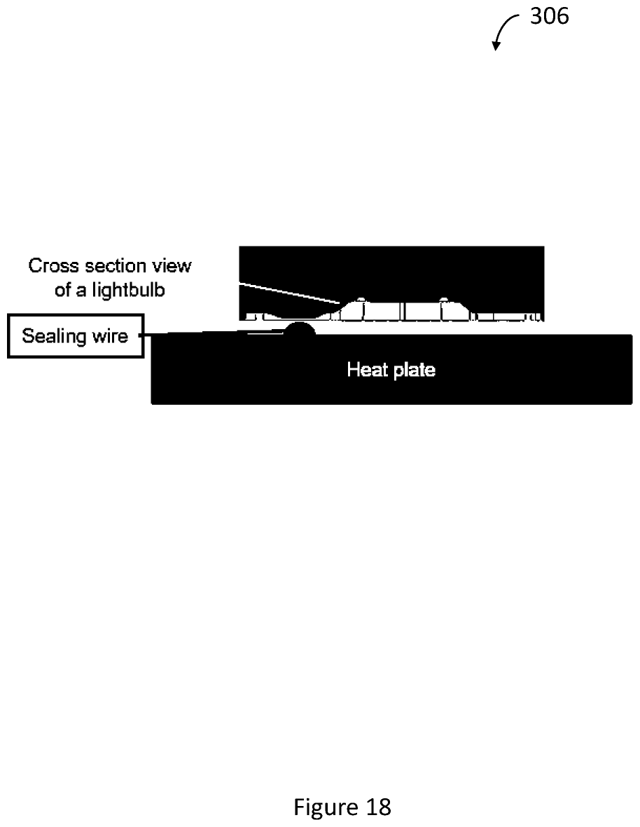

Referring FIG. 18, the microfluidic analyzer 300 further comprises a lightbulbs sealing module 306 comprising a sealing wire. The sealing wire is disposed at a position which is in a proximity to the inlets of the lightbulbs 262 when the cartridge 200 is at the operation position in the microfluidic analyzer 300. The sealing wire is configured to produce heat to melt the material of the inlets of the lightbulbs 262, thereby sealing the inlets of the lightbulbs 224.

In one embodiment, the sealing wire is disposed on the heating plate. In some examples, the sealing wire may be installed in any position which is in proximity to the inlet of the lightbulb 224.

In one embodiment, the high temperature releasing layer is coated on the sealing wire to prevent sticky contact to the plastic material of the cartridge 200.

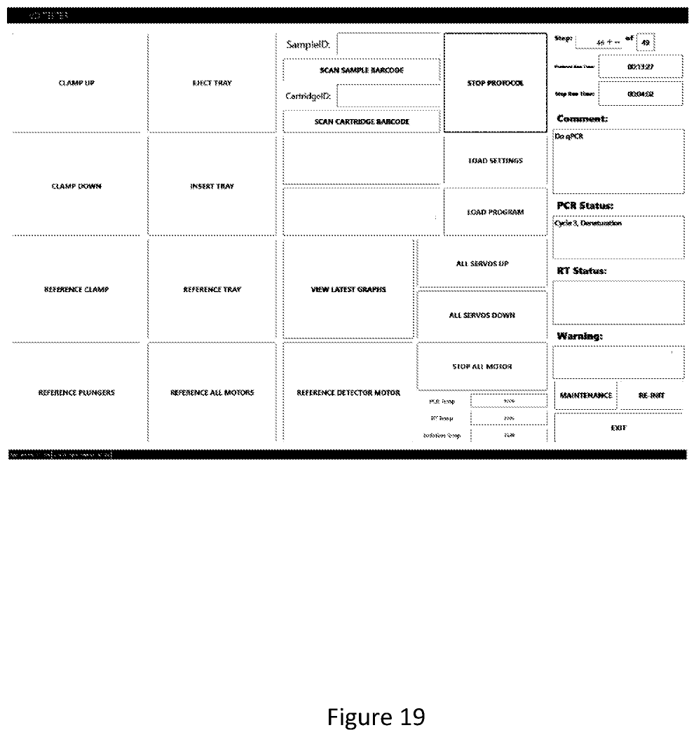

Referring FIG. 19, shows an user interface of the control application at the remote computer system 102 according to one embodiment of the present invention. It may provide controls to the operations at the microfluidic analyzer 300, including but not limited to the operations of the assay and its cartridge handling system. It also provides different mode of assay operations that can be perform on the microfluidic cartridge system 100. In some cases, the user interface is a graphic user interface (GUI).

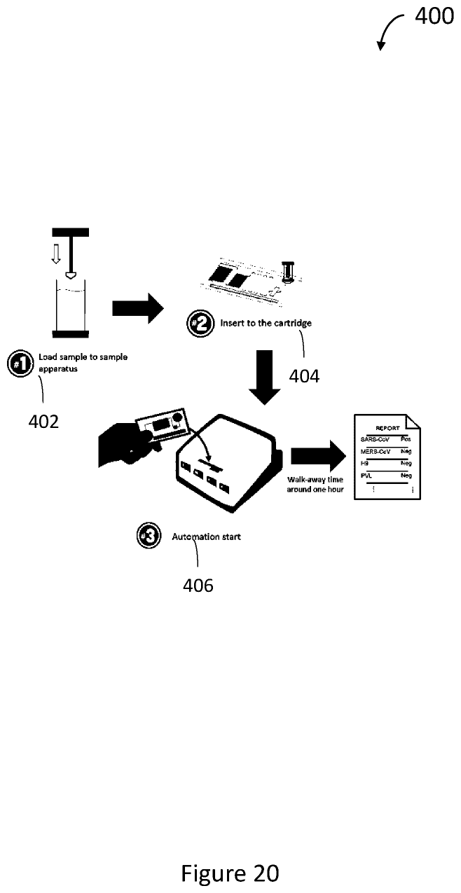

Referring FIG. 20, now turns to the method of an assay operation 400. First, in sample collecting step 402, the sample is collected and loaded into the sample apparatus 202. Then followed by sample inserting step 404, the sample apparatus 202 is inserted on the cartridge 200 at the sample tank 204. Then the cartridge 200 will be transferred onto the cartridge slot 304 of the retractable tray 302 at its extended position in cartridge loading step 406. Assay step 408 can be initiated by the input(s) of the user at the remote computer system or at the user interface of the microfluidic analyzer.

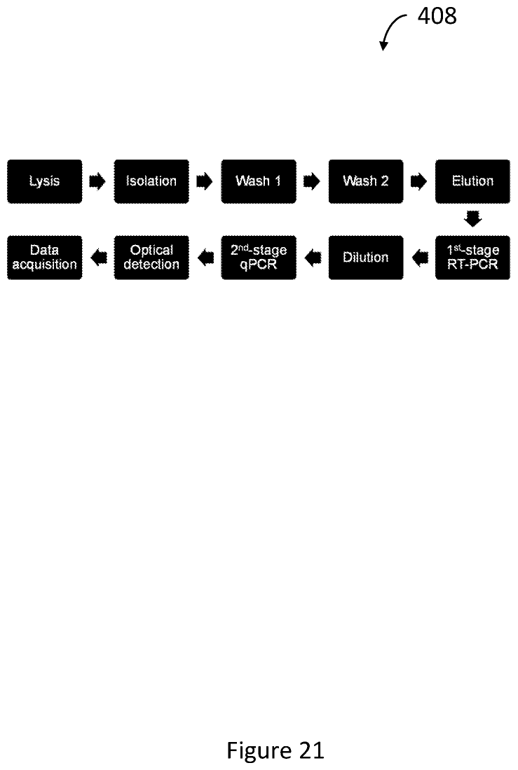

Referring to FIG. 21, the microcontroller of the microfluidic analyzer causes the following operations in the cartridge in the assay step 408:—

First in lysis step, the sample being analyzed is load to the lysis tank 206. Then, the sample in the lysis tank 206 is mixed with lysis buffer from lysis reagent tank 210a. An ultrasonic horn is turned on to agitate violently the silica beads in the lysis tank 206 for breaking down the surface structure of the analyte in the sample so that the nucleic acids are released and suspended in the lysis buffer.

In isolation step, the binding buffer in the binding reagent tank 210b flows into the lysis tank 206 for enhancing binding ability of nucleic acids to the isolation membrane 242. The mixture then flows to the waste collection tank 212 through the extraction module 214, where the isolation membrane 242 is located. The nucleic acid is captured by and attached to the membrane 242.

Following washing steps 1 & 2 with using washing buffers from the washing buffer reagent tank 210c and washing buffer reagent tank 210d respectively to the isolation membrane 242, the nucleic acids are eluted by flowing elution buffer from the elution buffer tank 210e to the isolation membrane 242 in the elution step.

RT-PCR master mix from RT-PCR master mix tank 210f together with eluent are pushed to RT-PCR chamber 216 through the first metering chamber 218a to undergo reverse transcription (RT) and 1st round of PCR amplification in 1st stage RT-PCR step.

The amplicon in the RT-PCR is pushed to the second metering chamber 218b in dilution step. Dilution ratio of the amplicon is depended on the size of metering chamber 218.

In the 2nd stage qPCR step, real-time PCR master-mix in the real-time PCR master-mix tank 210g is flowed through the metering chamber 218 to reach the pre-qPCR tank 220. In this step, the diluted amplicon is mixed with PCR master-mix for the 2nd round amplification. The mixture in the pre-qPCR tank 220 is loaded to the qPCR lightbulb quantitative region 222, evenly aliquoted to 120 lightbulbs 224. Each lightbulb 224 contains single specific primers/probes for pathogen (using spotting machine, one of the production process). After the loading, the lightbulbs 224 are sealed.

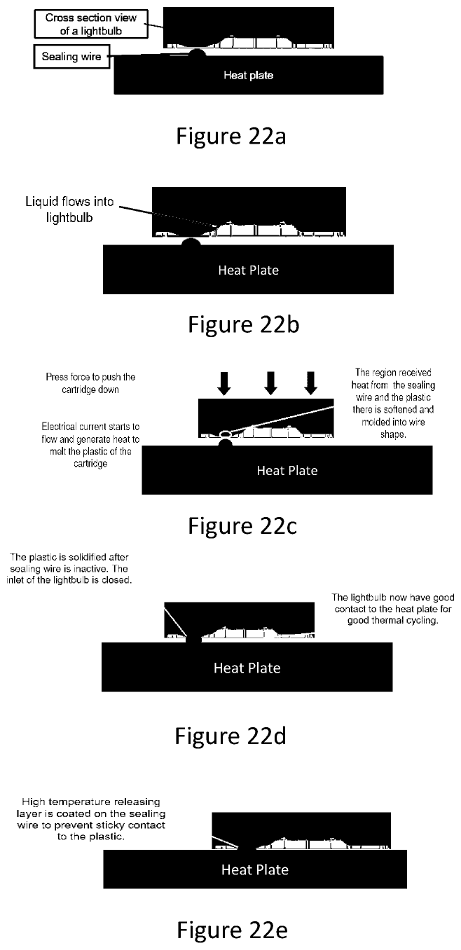

FIGS. 22a-e show the process of sealing the lightbulbs 224. First, the cartridge 200 is loaded into the microfluidic analyzer 300 and the placing the microfluidic analyzer 300 place the cartridge 200 at the operation position therein. At this position, the sealing wire is located at the bottom of the inlets of the lightbulbs 262 as shown in FIG. 21a. As the assay starts, the templates flow into the lightbulbs 224 and loading it with the templates as shown in FIG. 21b. As soon as all the lightbulbs are loaded, the cartridge 200 is pressed against the sealing wire as shown in FIG. 21c. As the same time, electrical current starts to flow through the sealing wire and generate heat to melt the inlets of the lightbulbs 262 thereby sealing the lightbulbs 224 as shown in FIG. 21d-e. Further, since the cartridge 200 is pressed against the sealing wire and the heat plate, the lightbulb 224 now have good contact with the heat place, which provides good thermal cycling for qPCR.

As the thermal cycle starts, the detection module moves across the qPCR lightbulb quantitative region 222 to pick up the fluorescence signals from the lightbulbs 224 in each cycle. i.e. quantitative real-time PCR can be realized in optical detection step.

In one example, the total number of cycles in a single run is 40.

The florescent light is induced by the illumination source at a desired wavelength and is captured by the detection module.

In data acquisition step, the image or spectrum data is then send to the remote computer system for further data analysis.

In one embodiment, the detection module is placed at distance where its field of view covers the whole the qPCR lightbulb quantitative region 222. The detection module does not move across the qPCR lightbulb quantitative region 222, but to pick up the fluorescence signals from all the lightbulbs 224 all at once in each cycle.

In one embodiment, the desired wavelength is ranging from about approximately 250 nm (ultra-violet) to about approximately 880 nm (infrared). In one example, the illumination source is coped with suitable filter for different setup.

In some examples, three lightbulbs 224 are used together as a set to detect a single kind of pathogen. That means, all those three lightbulbs 224 are contains same specific primers/probes for pathogen. In this setup, 40 different pathogens can be detected in a single run which last about approximately an hour.

In some example, one lightbulb 224 are used to detect a single kind of pathogen. In this setup, 120 different pathogens can be detected in a single run which last about approximately an hour.

In one specific embodiment, the assay system can detect 25 different virus and 12 different bacteria in one go. The viruses and the bacteria to be detected are picked from the list in table 1 (updated a new table, please noted):

TABLE 1
25 viruses

| | |
|---|---|
| Adenovirus | Enterovirus |
| Bocavirus | Influenza A, A/H1, A/H3, A/H1-2009, |
| Coronavirus | B, H5, H7, H9, H2, H6, H10 |
| nCoV, HKU1, NL63, 229E, | Parainfluenze Virus 1, 2, 3, 4 |
| OC43, SARS, MERS | Respiratory Syncytial Virus |
| Metapneumovirus | |
| Rhinovirus | |

12 bacteria

| | |
|---|---|
| Bordetella pertussis | Cryptococcus neoformans |
| Chlamydophilia pneumoniae | Pneumocysitis jirovecii |
| Mycoplasma pneumoniae | Burkholderia pseudomallei |
| Clamydophila psittaci | Coxiella burnetii |
| Legionella pneumophila | Staphylococcus aureus PVL |
| Mycobacterium tuberculosis | Streptococcus pyogenes |

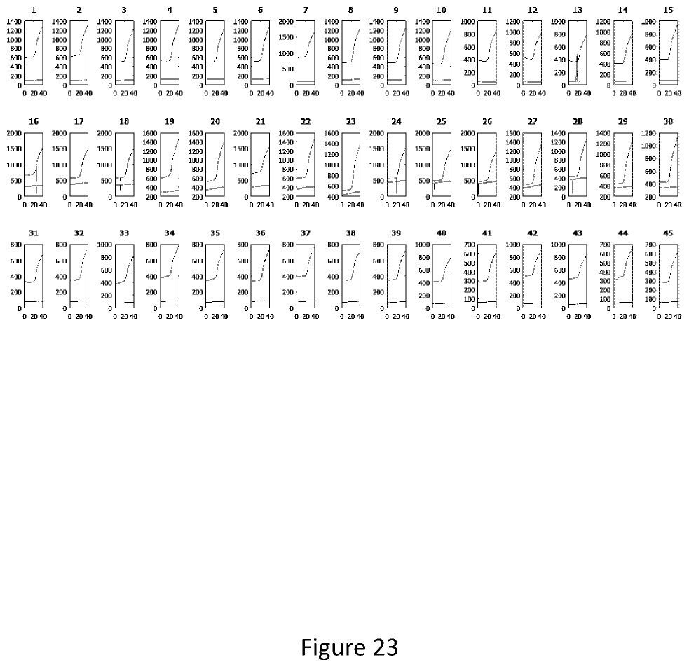

To demonstrate the usability of the assay system of the present invention, control materials dispensed in the sample apparatus 202 and processed solely by the system itself automatically. FIG. 23 shows excellent amplification curves with Ct values consistent with benchtop operation were obtained. The upper curves and lower curves represented fluorescence signals of FAM (probes) and Cy5 (passive reference dye), respectively, against each thermal cycle in the qPCR process.

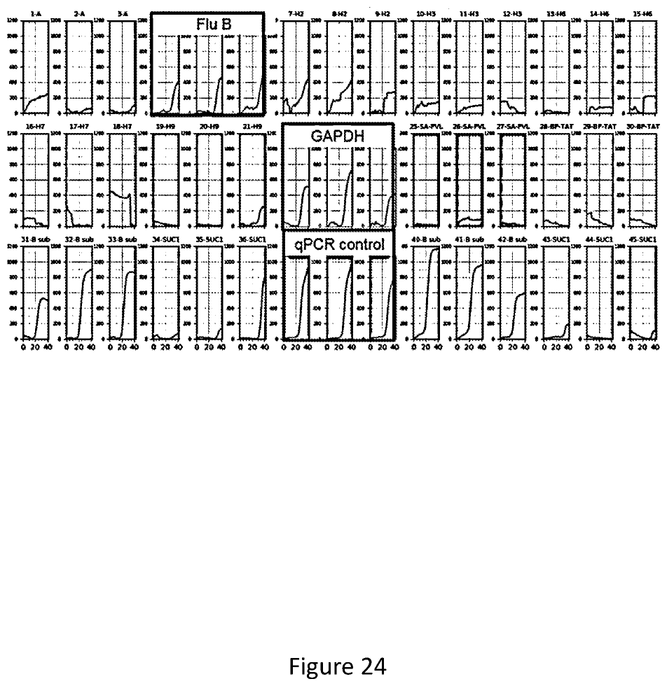

Referring FIG. 24, amplification curved obtained from each lightbulbs of the cartridge for the run with 20 μl clinical sample. The clinical sample was confirmed to contain Influenza B virus through benchtop procedure. Detail of this experiment was that 20 μl NPA sample was suspended in 780 μl VTM. The NPA sample was previously confirmed to have Flu-B infected. RNA extracted from S. pombe and B-Sub plasmids were used as controls for extraction and 1st-stage amplification, respectively. The run was rather smooth. Distinguishably fine-shaped amplification curves were successfully obtained from the lightbulbs that contained primers and probes of Flu-B, GAPDH and three other controls, i.e. qPCR, SUC-1 and B-sub. On the other hands, irregularly patterned signals were obtained from the other lightbulbs containing primer and probes non-specific to the pathogens. This result has demonstrated a fully automated system to detect pathogens in real clinical sample.

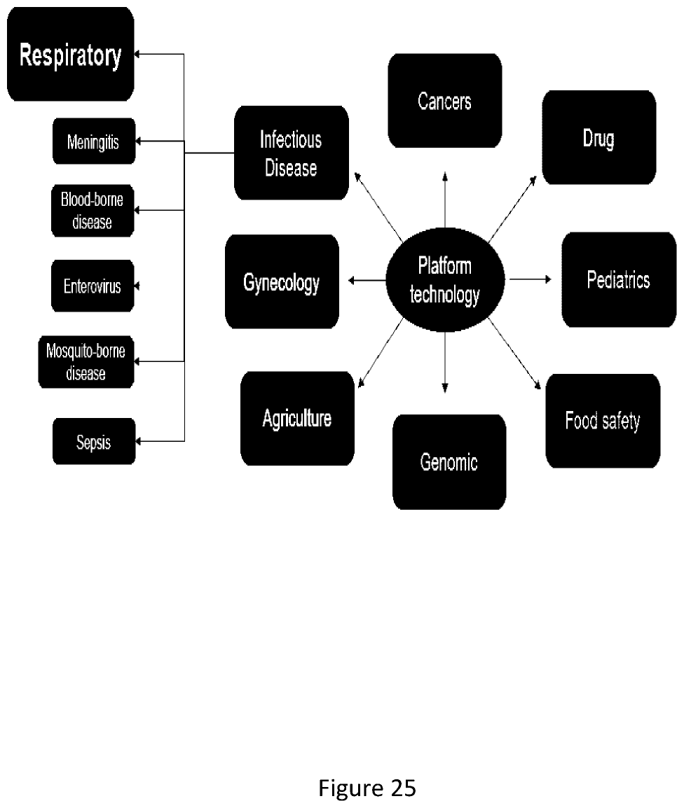

FIG. 25 shows the fields which the assay system of the present invention may be applied to. Although the embodiment disclosed above is related to biological/diagnostics assay, the present invention can be used to detect other non-biological analyte as long as the lightbulbs are spotted with appropriate probes. As such, the present invention provide a rapid, accurate, multiplex, low cost, sample-to-result, fully automated system platform for detecting analyte in different fields.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Python using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A fully automated microfluidic system for detecting multiple different analytes in a single run comprising:
a remote computer system;
a microfluidic analyzer connected with the remote computer system having a illumination source and a detection module; and
a cartridge having a plurality of lightbulbs, a sample tank and at least one reagent tank, wherein each lightbulb is sealable by the microfluidic analyzer.

2. The fully automated microfluidic system of claim 1, wherein the detection module comprises a camera.

3. The fully automated microfluidic system of claim 1, wherein the cartridge comprises spaces to hold up to 40 respiratory pathogens.

4. The fully automated microfluidic system of claim 3, wherein the remote computer system completes the analysis in about one hour.

5. A fully automated microfluidic system for detecting 40 different analytes in a single run in about approximately an hour comprising:
a remote computer system;
a microfluidic analyzer connected with the remote computer system having a illumination source and a detection module; and
a cartridge having a plurality of lightbulbs, a sample tank and at least one reagent tank.

6. The fully automated microfluidic system of claim 5, wherein the detection module comprises a camera.

7. The fully automated microfluidic system of claim 5, wherein the cartridge comprises spaces to hold up to 40 respiratory pathogens.

8. The fully automated microfluidic system of claim 7, wherein the remote computer system completes the analysis in about one hour.

9. A substantially automated microfluidic system for detecting multiple analytes with different biological contents comprising:
a remote computer system;
a microfluidic analyzer connected with the remote computer system having a illumination source and a detection module;
a cartridge having a plurality of lightbulbs, a sample tank and at least one reagent tank, wherein each lightbulb is sealable by the microfluidic analyzer; and
wherein the remote computer system analyzes the multiple analytes associated with the cartridge while all of the analytes are being processed.

10. The fully automated microfluidic system of claim 9, wherein the detection module comprises a camera.

11. The fully automated microfluidic system of claim 9, wherein the cartridge comprises spaces to hold up to 40 respiratory pathogens.

12. The fully automated microfluidic system of claim 9, wherein the remote computer system completes the analysis in about one hour.

13. A method for analyzing the multiple analytes according to claim 9.
